(19) United States
(12) Patent Application Publication
(10) Pub. No.: US 2009/0191921 A1
(43) Pub. Date: Jul. 30, 2009

(54) Remote Annunciator System and Method for a Plurality of Wireless Handheld Devices

(76) Inventor: Larry J. Manatrey, Bloomfield Hills, MI (US)

Correspondence Address: JOHN R. BENEFIEL, 525 Lewis Street, BIRMINGHAM, MI, 48009, US

(21) Appl. No.: 12/361,754

(22) Filed: Jan. 29, 2009

Related U.S. Application Data
(60) Provisional application No. 61/062,743, filed on Jan. 29, 2008.

(51) Int. Cl. H04B 1/38

(52) U.S. Cl. 455/567

(57) ABSTRACT

A system and method for facilitating replacement of landlines with a wireless device system by remotely alerting a user of any one of a plurality of handheld wireless communication devices each having a characteristic call alert sounds, of an incoming communication in which any wireless communications device is placed in a holder-docking station which senses that there is an incoming communication to that wireless device and transmits signals corresponding to any device placed therein which causes one or more remotely located annunciators to broadcast characteristic sounds associated with the device placed in any holder-docking station.

### CROSS REFERENCE TO RELATED APPLICATIONS

This application claims the benefit of U.S. provisional Ser. No. 61/062,743, filed on Jan. 29, 2008.

### BACKGROUND OF THE INVENTION

This invention concerns handheld wireless communications devices such as cell phones, Blackberry's, etc. which are designed to receive wireless communications. Such devices have built-in annunciators to alert the owners of an incoming call or other communication such as a text message, email, etc.

Such handheld wireless devices are designed to be kept in close proximity to their user, either carried on the person or inside personal carry-around cases or bags such as briefcases or purses. But users of such wireless devices find that they are oftentimes not able to keep them close by. This is particularly true when the user is at home. Women typically keep such wireless devices in their purses and, upon arriving home, often will set their purses down in a certain place where it stays with the phone inside while she moves about the other areas of the house. Or, the user must periodically place his wireless device in a particular location in the home while the wireless device is being charged and inevitably moves about the house away from it.

When the user of such a wireless device moves about the house (or outside the house) without the device, he or she may not be where these incoming message alert sounds can be heard and is therefore unaware when a communication is being received on his or her wireless device, resulting in frequently missed communications.

Also, as the popularity of these handheld wireless devices grows, the users of such devices find it less necessary to continue keeping, and thus paying for, home landline telephone service and have turned instead to relying just on their wireless devices for their home telephone system. But because these built-in call alert signaling annunciators were not designed to be heard over a large area of operation, they are all limited when used as a replacement for a landline phone in a home or office. For example, extensions cannot be used to alert their users in other rooms of an incoming call in the same way landline telephone systems can, so when the user moves away from the wireless device and goes to other areas of the home, he or she often can't hear when an incoming message alert signal is sounded from that device. Therefore, if the user opts to discontinue their landline phone service, they are now required to keep their handheld wireless device with them at all times when at home. Since this inevitably is not always done or practical, incoming communications are often missed.

Another factor complicating the use of a cell phone, Blackberry or other similar hand held wireless device for an exclusive household telephone system is the fact that each person in the household often has their own individual wireless device, each with its own different phone number identity. That means if each user in this environment wants to be remotely alerted to an incoming communication on their wireless device when away from that device, they must each have their own independent system for that remote notification. As noted above, such devices cannot have extensions in the way a landline phone system can for obvious technical reasons.

Remote specialized call alert signaling devices have been proposed for some communication and security devices but heretofore have not been designed to adequately address the problems encountered in trying to replace an existing landline telephone system in the home or office with handheld wireless devices.

Prior art designs for remote call alert indicators have usually involved a built-in transmitter located inside a cell phone, Blackberry, or other handheld wireless device which activates a separate signaling device. Such designs make no provisions for the use of such a system by wireless devices not equipped with such a built-in transmitter. Also, most of these call alert indicators can only accommodate one wireless device at a time and do not provide separate signal alerts for any other users of similar wireless devices within their area of operation. And none of these prior designs actually alerts multiple users by broadcasting the actual audio alert ring sounds of the specific wireless device that is receiving the incoming communication over multiple annunciators.

See U.S. Pat. No. 7,203,524 B2; U.S. Pat. No. 5,960,367; U.S. 2001/0023195; and U.S. 2004/0204153 for examples in which signaling devices are used when the cell phone is close to the user and are designed to insure that the person carrying the cell phone is alerted to an incoming call. In these cases, the wireless device must be in close proximity to the user at all times to receive the intended communications alert and does not provide for separate communications alerts for multiple wireless users at a distance or in other areas.

U.S. 2002/0032020 A1 and U.S. Pat. No. 5,722,071 describes a plurality of separate alert devices which will provide a sensible call alert signal bin neither provides a system that actually pass through the actual audio alert ring sounds of the specific wireless device that is receiving the incoming communication over multiple annunciators.

U.S. 2008/0293453 A1 shows a separate sensor for sensing a sound signal emitted by the cell phone and activates a separate indicator carried by a cell phone user on or about their person. In this case, again the wireless device must be in close proximity to the user at all times to receive the intended communication alerts and it does not provide a system that can be used over open distances by multiple users nor does it provide a system that actually alerts multiple users by broadcasting the actual audio alert ring sounds of the specific wireless device that is receiving the incoming communication over multiple annunciators for separate communications alerts for multiple wireless users at a distance.

It would be advantageous if such a system could be provided for existing wireless devices not having such transmitters built-in which also would provide remote alerts of incoming communications when the wireless device is not in close proximity to the user; allow such alerts to be effectively given at a distance and in a number of places within a given area; and, one that allows for multiple individual wireless users to also be remotely alerted to incoming communication on their own individual wireless devices within the same system by broadcasting the actual audio alert ring sounds of the specific wireless device that is receiving the incoming communication over multiple annunciators.

An object of the present invention is to provide a remote signaling alerting system for wireless communication devices to solve the aforementioned problems created in a home, office, or in any entered area where a number of different people are present each having their own cell phones and/or other handheld wireless communication devices, and to specifically design that system so that multiple users within that system can immediately know when their specific wireless device is receiving an incoming communication.

It is another object of the present invention to provide a simple system and method for remotely alerting users of cell phones, Blackberry's and other handheld wireless devices which are not equipped with built-in signal transmitters of incoming communications when the user does not have the device on or about them or close by.

It is a further object of the present invention to provide a remote signaling alerting system for wireless communication devices which is able to operate simultaneously at a distance and in many places within a given area of operation.

### SUMMARY OF THE INVENTION

These objects as well as other objects which will be appreciated and understood by those skilled in the art upon reading the following specification and claims are achieved by a system and method including one or more holder-docking stations into which any type of handheld communicating wireless device may be placed.

Each holder-docking station is equipped with a sensor such as a microphone or piezoelectric transducer with detects sounds or vibrations produced by a cell phone, Blackberry or other wireless device placed in a holder-docking station within the system.

Each holder-docking station also includes a transmitter for sensing and sending the actual audio ring alert sounds produced by the particular handheld wireless communication device itself simultaneously to provide a call alert to all of the one or more remote portable annunciations which are placed in different locations also included in the system and method, linked to the one or more holder-docking stations.

In an alternate embodiment of the invention, a specific wireless device is distinguished from other wireless devices by providing an ability for each user to select a personal individual setting oh the holder-docking station into which his or her wireless device is placed. That holder-docking station reads and transmits a coded identifier signal that is associated with that particular setting on that particular holder-docking station.

A variation of this alternative is for the holder-docking station component to be able to read a unique identifier signal from a tag or marking placed on each wireless device using the system.

In either instance, the coded identifier signal is transmitted to all of the annunciators, identifying the particular setting by the user on that holder-docking station with all of the annunciators emitting the same set of preset unique alert sounds associated with that particular setting.

All annunciators are portable and accordingly can be moved about to various locations away from the holder-docking stations. Each contain special receiver circuitry to detect and reproduce the sounds corresponding to the specific signals being sent from any holder-docking station transmitter, or to emit preset unique alert sounds in the alternate embodiment described.

Accordingly, each individual user of the system will immediately recognize his or her own set of unique alert sounds emanating from any annunciator and thereby be alerted that a transmission is currently being received by his or her own wireless device. This will be recognizable to the each user because the holder-docking station will be transmitting a signal containing either the actual audio ring sounds of that user's individual wireless device or in the alternate embodiment some other preset set of sounds unique to his or her application and those sounds will be broadcast from all of the remote annunciators. In the case of the first instance of design, all users of the system will not only be able to immediately recognize that their wireless device is currently receiving an incoming communication, but with each individual wireless device being able to have a different ring alert sound assigned to each of their contacts, the user will also immediately know which of his contacts is making the incoming communication. In this way, the user may wish to go to his device and answer the communication then or to allow his wireless device to let the communications go to voice mail opting to return it later. That makes this system truly unique in the remote annunciator field of invention.

Although the alternate embodiment optional design is more limited in its alert sounds, each user will still easily be able to recognize the assigned preset ring sounds that the user has set into the system at the holder-docking station containing their particular wireless device.

A plurality of holder-docking stations can be provided so that a plurality of wireless devices can be accommodated simultaneously within the system, each able to transmit to the same sets of annunciators, thereby allowing anyone in the household with a wireless device to be remotely alerted by all of the annunciators that an incoming communication is currently being received on his or her wireless device, eliminating a reason to continue to maintain a landline telephone system in the household.

### DESCRIPTION OF THE DRAWING FIGURES

FIG. 1 is a pictorial view of a holder-docking station according to the invention with a wireless communications device, in this case a cell phone, placed therein.

FIG. 1A is a pictorial reduced side view of the holder-docking station according to the invention with a wireless communications device, in this case a cell phone is placed therein.

FIG. 2 is a pictorial view of an annunciator according to the present invention.

FIG. 3 is a diagrammatic representation of a house with a number of holder-docking stations and annunciators indicated therein at various locations within the house.

FIG. 4 is a block diagram of the various electronic components included in each holder-docking station and annunciator included in a system according to the invention.

### DETAILED DESCRIPTION

In the following detailed description, certain specific terminology will be employed for

the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

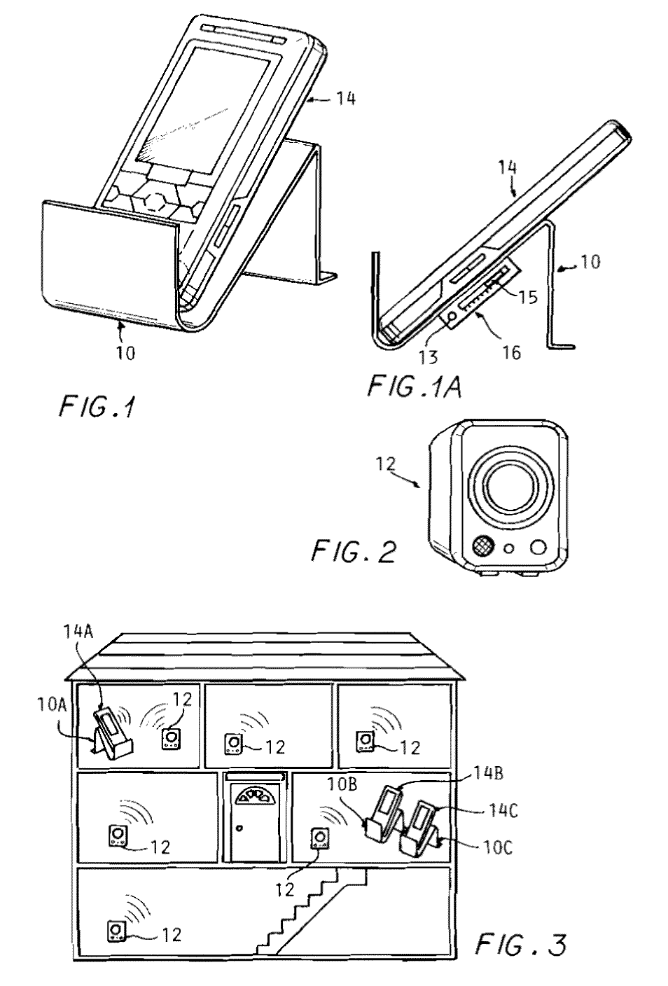

A remote wireless communication alerting system and method according to the invention includes one or more holder-docking stations 10 (FIGS. 1 and 1A) and one or more remote annunciators 12 (FIG. 2) placed at one or more remote locations within a given area (FIG. 3). The system and method is intended to provide a remote alert to the user of a wireless communication device 14 that an incoming communication is being received by that device, and features an ability to provide such remote alerts for any of a plurality of handheld wireless communication devices 14 when such devices have been placed in one or more holder-docking stations 10 within an operational area. (See FIGS. 1 and 1A)

The system includes a sensor-transmitter 16 included on each holder-docking station 10 and one or more remote annunciators 12 (FIG. 2) which also have components (described below) which receive and generate call alert signals audible in an area where each annunciator is located.

Any handheld wireless communication device 14 may be placed in a docking station 10 such as cellular phone, Blackberry, etc.

Alert sounds generated by a wireless device 14 when an incoming call and/or text communication is being received are detected by the sensor-transmitter 16 of a holder-docking station 10 and signals corresponding to those alert sounds are transmitted to all of the one or more annunciators 12.

The annunciators 12 are placed at various locations throughout a home or office. (See FIG. 3) Each of the annunciators 12 generates alert sounds at its location. One or more holder-docking stations 10A, 10B, 10C, etc., may be provided, each able to hold an individual wireless device, 14A, 14B, 14C, etc. for the purposes of detecting an incoming call and/or text message to any one of the devices 14A, 14B, 14C. Signals from the holder-docking station 10 are sent to all of the one or more remote annunciators 12 indicating that a call, text message, or other communication is currently being received by that particular wireless device 14A, 14B, or 14C.

Each holder-docking station 10A, 10B, 10C is only activated when a wireless device 14 is placed in a holder-docking station 10A, 10B, 10C. When a wireless device 14A, 14B, 14C sounds while in the holding-docking station 10, the sounds are detected and its sensor-transmitter circuitry 16 is activated. The sensor transmitter 16 transmits sends signals corresponding to the actual alert sounds emanating from that specific wireless device 14A, 14B, or 14C.

When each annunciator 12 receives these signals from any holder-docking station 10A, 10B, or 10C, it reproduces the actual audio alert ring sounds emanating from that specific wireless device 14A, 14B, or 14C, placed therein, to alert the user of that device 14A, 14B, or 14C that there is an incoming call, text message, etc. being received by his or her wireless device 14A, 14B, or 14C. The alert sounds are continued to be broadcast by all of the annunciators 12 as long as the wireless device 14A, 14B, or 14C is in a docking station 10A, 10B or 10C and alert sounds are being emitted therefrom.

Or in the alternate embodiment, it may be optionally designed for the sensor-transmitters 16 to respond by sensing an alert sound or a vibration of a wireless device 14A, 14B, or 14C and then transmitting a uniquely coded identifier signal associated with each user setting on the user selector switch 15 at any of the holder-docking stations 10 and sent to all of the various annunciators 12 located throughout the area serviced by the system and corresponding preset alert audio alert sounds unique to each setting are generated as described below in further detail.

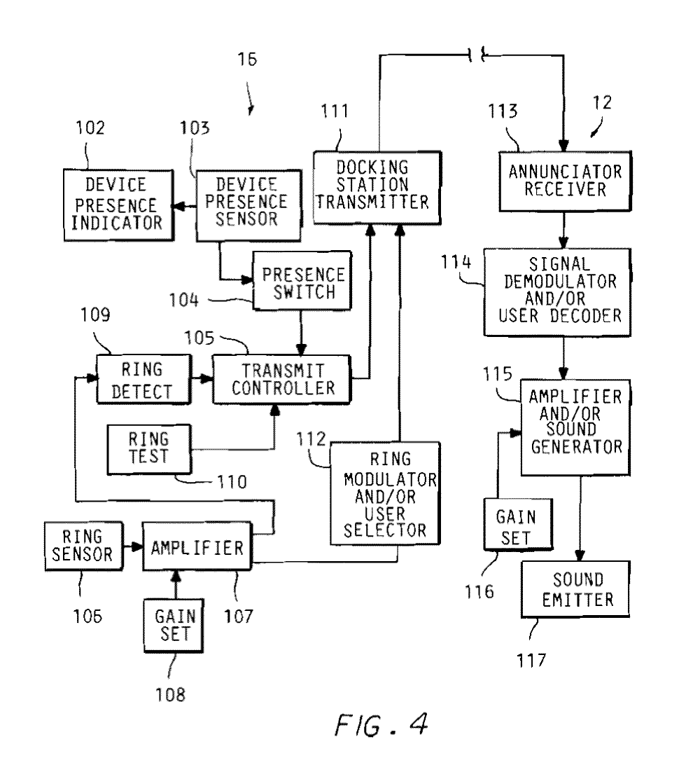

There is a communication link between all of the holder-docking station transmitters 111 and receivers 113 contained in each of the annunciators 12 as indicated in FIG. 4. This link can consist of, but not be limited to: RF carrier waves with optional modulation; telephone cable; data cable; carrier wave over AC power; Blue Tooth technology; the Ether, or various other means of recognized signal transmission and reception over a given distance.

In each of the holder-docking stations 10A, 10B 10C, a power operational light 13 comprising a device presence indicator 102 shows that the system has been energized by the presence of a wireless device 14A, 14B, or 14C in that holder-docking station. 10A, 10B, or 10C (FIG. 2).

A device presence sensor 103 can be a mechanical or proximity switch to activate the system when a wireless device 14 is present in a holder-docking station 10.

The ring sensor 106 included in the sensor-transmitter 16 detects the alert sounds emanating from a wireless device 14 when it receives an incoming call and/or text message. The ring sensor 106 is typically a microphone or piezoelectric transducer which produces small signal voltages in response to detection of an audible ring or vibration from a wireless device 14. A signal is then generated and sent on to the amplifier 107 where it is amplified.

The signal is filtered and detected by the ring detect circuitry 109 which filters out extraneous noise and produces a logic signal indicating that the detected signal is in fact a valid alert sound signal. This is necessary to prevent room noises from accidentally triggering the system. This logic signal is the primary input to the transmit controller 105.

The transmit controller 105 is a logic switch that controls the holder-docking station transmitter 111 included in the sensor-transmitter 16. When it has a presence command from both the presence switch 104 and from the ring detector 109, it is keyed “on” and begins transmitting the signal sent over the communications link. This keeps the transmitter 111 from transmitting when only one of those conditions is met.

The gain set 108 provides for an optional adjustment of the sound amplifier 107 gain. It can be equipped with an electronic automatic gain control system in place of, or in addition to, a manual gain control.

The transmitter 111 is keyed “on” when a command signal is received from the transmitter controller 105. This signal can be a simple carrier wave that is keyed “on” and “off” to indicate the presence of a received alert sound and/or text message that is currently being sent to that wireless device 14. The signal goes from the amplifier 107 to the modulator and/or user selector 112. From there, the amplified signals corresponding to the actual audio alert ring sounds of that wireless device 14 are sent directly to the holder-docking station transmitter 111 for transmission to the annunciators 12 which reproduce and broadcast those same sounds.

In the alternative embodiment of the invention, the system may be designed to provide a modulation system that produces identifier signals to specifically identify a particular wireless device 14A, 14B, 14C, etc. onto the carrier wave using a typical modulation system. This may be accomplished by the modulator and/or user selector 112 which may contain a user selector switch 15 (FIG. 1). The selector switch 15 is set to a position corresponding to a particular user in the system which causes the transmitter 16 to send a signal unique to each setting. In this embodiment, all of the annunciator units 12 emit a set of preset unique sounds each corresponding with the user selected setting as set on the user selector switch 15 on the particular holder docking station 10 where the user's wireless device has been placed.

The particular wireless device 14A, 14B or 14C placed into a holder-docking station 10A, 10B or 10C may also alternately be identified automatically, as by placing a sensor readable identifier (not shown) thereon or derived from automatic recognition circuitry designed specifically to identify each particular individual wireless device placed in a holder-docking station. The transmitter 16 will transmit a coded signal to all of the annunciators 12 to cause the preset unique sounds corresponding to each of the settings on the user selection switch 15 on any holder-docking station 10A, 10B, or 10C to be broadcast.

A test activation button 110 is provided to test the system by momentarily activating the docking station transmitter 111 when pressed.

Each annunciator 12 detects the signals sent by any holder-docking station transmitter 111 and rebroadcasts the actual audio alert ring sounds of the particular wireless device 14 housed in that holder-docking station 10 or in the alternate embodiment, detects and decodes associated coded signals sent from a holder-docking station 10A, 10B, or 10C and emits one of a series of pre-set sounds to indicate that there is currently an incoming call and/or text message being sent to that wireless device 14A, 14B or 14C in that specific holder-docking station 10A, 10B or 10C.

Local AC electrical or battery powered operation is provided for the electronic components, in conventional fashion.

The annunciator signal demodulator and/or user decoder 114 receives the signal containing the actual alert sounds emitted by the wireless device 14, and sends them on to the amplifier and/or sound generator 115 or in the alternate embodiment, the signal demodulator and/or user decoder 114 would demodulate the received signal and identify that signal based on the user selector setting on the user selection switch 15 on the transmitting holder-docking station 10. In this embodiment, the amplifier and/or sound generator 115 would produce an amplified set of sound patterns consisting of a present sequence of tones, beeps and/or other alert sounds which have distinct and identifiable signatures. The sounds can be reproductions of the actual alert ring sounds emitted by a wireless device 14 or in the alternative embodiment, other prerecorded sets of sound patterns already preset into the annunciator 12.

The output of the amplifier and/or sound generator 115 contains the actual audio alert ring sounds of a particular wireless device or, in the alternative embodiment, the preset other sounds corresponding to the particular setting set by the user on the user selection switch 15 or by other identifier means is then applied to the sound emitter 117, such as a loudspeaker or piezoelectric transducer which is capable of producing sufficient sound pressure level to be audible within a prescribed distance.

The optional gain set 116 sets the level of the sound to be generated according to the needs of the user.

Thus, with this system in place, a user of any one of a plurality of wireless devices 14A, 14B, or 14C in a home or office by simply placing their wireless device 14 in any holder-docking station 10 can be remotely alerted to an incoming call on his or her specific individual wireless device 14 by the sounds being emitted from all of the annunciators 12.

As indicated in FIG. 3, grouping of two or more holder-docking stations 10A, 10B, 10C can be provided so other individual users can put their wireless devices 14 in any of the other holder-docking stations 10A, 10B, or 10C and can also be remotely alerted to an incoming call on his or her wireless device 14 by all of the annunciators 12. Alternatively, other holder-docking station 10 can be added and placed in a separate location as well for use of another user and so on (FIG. 3).

In either event, all of the annunciators 12 will broadcast the alert sounds associated with each individual wireless devices 14A, 14B, or 14C within the given area of operation.

Since the system is compatible with all wireless charging hardware, any wireless device 14 can also be charged while being held in any holder-docking station 10.

Another advantage of the invention is realized by the broadcasting by each annunciator 12 of the actual audio alert ring sounds from a specific individual wireless device 14A, 14B or 14C when alert sounds are associated with the caller sending the incoming communication. That is, if the user has specific ring tones assigned to specific persons, the user hearing the sound from any annunciator at any of the remote locations will be immediately familiar of who is actually calling his wireless device so that he or she can decide at that time whether to answer it then or to let the call go to voice mail and return it at a later time.

1. A system for providing alert sounds for an incoming communication to a wireless communication device which itself generates characteristic sounds upon receiving said communication, comprising;
a holder-docking station having a sensor-transmitter and configured to receive and hold said wireless device, which sense said generation of said characteristic sounds and transmits signals corresponding to said characteristic sounds to one or more annunciators remote from said holder-docking station and which each include a receiver receiving said signals from said holder docking station reproduces said alert sounds upon receipt thereof from the said holder-docking station sensor-transmitter.

2. A system for providing characteristic alert sounds for an incoming communication from any of a plurality of portable handheld wireless communication devices, each of said devices generating sounds characteristic of each of those devices comprising;
a holder-docking station being adapted to hold any of said devices and having a sensor-transmitter and which senses said characteristic sounds generated by any of said devices placed therein and transmits corresponding signal to at least one remote annunciator having a receiver receiving said signals from said sensor transmitter and recreating said characteristic alert sounds of any of said plurality of wireless devices placed therein.

3. The system according to claim 2 wherein a plurality of holder-docking stations each having a sensor-transmitter with each holder-docking station able to hold any of said wireless devices and sense any of said unique characteristic sounds generated thereby and transmit corresponding signals of said at least one annunciator.

4. The system according to claim 3 including a plurality of said annunciators having receivers each at remote location, each annunciator receiver receiving signals corresponding to characteristic sounds of any of said devices transmitted by any of said holder docking stations and recreating therefrom a corresponding characteristic alert sounds.

5. A method of remotely alerting a user of one of a plurality of wireless devices that an incoming communication to a particular one of a said plurality of handheld wireless communicating devices, each wireless device generations characteristic sounds upon receipt of an incoming communication, comprising:
placing any one of said plurality of handheld wireless communication devices into a holder-docking station having a sensor-transmitter that senses characteristic sounds emanating from any of said handheld wireless communication devices and transmit corresponding signals;
dispersing one or more annunciators at respective remote locations which each having a receiver receiving said transmitted signals and reproducing sounds unique to each wireless device at said locations thereof to alert said user if at any of said remote locations of the receipt of an incoming communication on said one of many specific wireless handheld communication devices.

6. The method according to claim 5 wherein said annunciators reproduce said characteristic sounds upon receiving said signals from said holder-docking station transmitter.

7. The method according to claim 6 wherein said signals reproduce said characteristic sounds in said annunciators.

8. The method according to claim 5 wherein said sounds unique to each wireless device are preset in said annunciators.
